(19) United States
(12) Patent Application Publication
(10) Pub. No.: US 2021/0201247 A1
(43) Pub. Date: Jul. 1, 2021

(54) SYSTEM AND METHOD TO ASSIGN ACTION ITEMS USING ARTIFICIAL INTELLIGENCE

(71) Applicant: Avaya Inc., Santa Clara, CO (US)

(72) Inventors: Sudhir Shelke, Pune (IN); Amol Navale, Pune (IN); Aonkar Takalikar, Pune (IN)

(21) Appl. No.: 16/730,456

(22) Filed: Dec. 30, 2019

(51) Int. Cl. G06Q 10/06; G06N 20/00; G06N 7/00; G06Q 10/10; G06F 40/279

(52) U.S. Cl. CPC G06Q 10/063114; G06N 20/00; G06F 40/279; G06Q 10/107; G06Q 10/063112; G06N 7/005

(57) ABSTRACT

A system and method for dynamically assigning action items using Artificial Intelligence based on criterion. The criterion including resource availability, resource location, and/or resource skill(s). The system and method comprising: monitoring communications over one or more communication channels; analyzing the monitored communications to generate one or more user stories; processing the one or more generated user stories to identify one or more action items; scoring one or more resources based on assignment factors to determine a resource with a highest score; and assigning the one or more action items to the resource with the highest score. The system and method further comprising: tracking action items and automatically updating action item status. The system and method also include automatically re-assigning action items as needed.

### FIELD

The disclosure relates generally to unified communications and particularly to systems and method for action items using artificial intelligence.

### BACKGROUND

Unified communications allow for the integration of enterprise communication services, such as instant messaging (chat), voice, conferencing (audio, video, web) desktop sharing, data sharing, voicemail, email, etc. to provide a consistent unified interface across multiple devices and service. In organizations today, there is often the need to collaborate with others and workers may interact with other users over multiple different channels. Some of these communications may be related to the same topic. For example, a user may discuss a project over email, in a phone conversation, and also during an in-person meeting at the office.

Meeting management systems provide users with a way to capture, distribute, and archive meeting information, but may not be able to capture information being communicated over multiple different channels.

The manual assignment and tracking of action items are time consuming and inefficient.

### SUMMARY

These and other needs are addressed by the various embodiments and configurations of the present disclosure.

The present disclosure can provide a number of advantages depending on the particular configuration.

The present disclosure provides a system and method for the life-cycle management of actions items.

The present disclosure allows the status of action items to be automatically updated, improving resource productivity.

The present disclosure uses historical and current data to improve planning (e.g., course of action suggestions) for improved results and improved decision making.

The present disclosure provides a holistic view of scattered action items recognized as a user story and assignment using preferences.

These and other advantages will be apparent from the disclosure contained herein.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system 100 for a method to assign action items using Artificial Intelligence (AI) based on criterion in accordance with the present disclosure.

FIGS. 2A-B illustrate an example user interface for manually creating action items in accordance with the present disclosure.

FIG. 3 illustrate an example user interface for viewing action items in accordance with the present disclosure.

FIG. 4 illustrate an example user interface for viewing action items in accordance with the present disclosure.

FIG. 5 illustrate an example user interface for viewing action items in accordance with the present disclosure

FIG. 6 is a flow diagram of assigning action items using AI in accordance in accordance with the present disclosure.

FIG. 7 is a block diagram illustrating a computing device for assigning action items using AI in accordance with the present disclosure.

### DETAILED DESCRIPTION

Currently a user may capture minutes of meetings and action items, however, there is no system that identifies relationships between action items. Furthermore, there is no system that processes communications over different communication channels (e.g., calls, chat, email, meetings, etc.) to identify action items. That is to say, relationships between action items are not considered to be part of a bigger task such as a user story. The system and method disclosed herein monitors communications through different channels, such as p2p calls, IM chats, emails, and conferences (remote and/or in person), the communications are analyzed using Artificial Intelligence (AI) to identify user stories from the monitored communications. In addition, one or more courses of action may be determined, and compared in order to determine the most efficient course of action. In some embodiments, the action items are determined based on the selected course of action.

A system and method to analyze multiple communication channels (e.g., calls, voicemails, emails, chats, conferences, etc.), and using AI identifies user stories to be delivered and suggests one or more probable course of actions. The user stories can be broken down into tasks and/or action items, which can be assigned using a criterion, such as expertise, co-location, availability, preferences, etc. The user stories and the generated action items may also be tracked automatically. Throughout the duration of the selected course of action, the resources are evaluated to determine if re-assignment is necessary. For example, if a resource is assigned one or more actions items, and before completion of the assigned work items, the resource is predicted to become unavailable (e.g., worker requests time off), then the system may determine that the unfinished actions items should be re-assigned to an available resource.

In addition to the action items being identified from multiple different communication channels, related action items are grouped and managed by a centralized system. The action items are categorized into groups based on the similarities and relationships between them (e.g., stakeholder, assignee, required skills, etc.). One or more probable courses of action for successful completion of the action items may also be suggested.

The stakeholders of the action items are identified and involved in the communications with respect to the action items under consideration by the system. The assignment of identified action items is managed by the system using machine learning algorithms. The system uses information such as the past performance of the probable assignee with respect to similar action items, the delivery success ratio, co-location of the resources and time zones of the teams under consideration, area(s) of interest of the resources, the skill levels of the probable assignee according to the requirement of the action items, time frame for delivery, availability of resources, external factors (e.g., impact on market, time of year, market-share conditions, availability of materials, budget, etc.).

Using this information, the system identifies the time required to complete an action item, the best assignee for the action item, and successors to pass the action item on, if needed. With the probable course of action, the system identifies teams or personnel for each of the identified probable courses and predicts a time frame for each probable course to carry out the task. This determination may be based on the task as a whole or broken down by individual action items that make up the overall task.

The identified action items and the chosen course of action (including the assigned resource) can then be tracked in a unified manner through the monitored communications. The status of the action item is automatically maintained and updated based on the tracking.

In this disclosure a system and method for life-cycle management of an action item is described. The action items are recognized in a unified manner from multiple possible communication channels. The relevant action items are grouped and managed by a centralized system. The action items will be categorized into groups based on the similarities found in them and are appropriately distributed. Probable courses of actions may also be suggested for the successful completion of the action items.

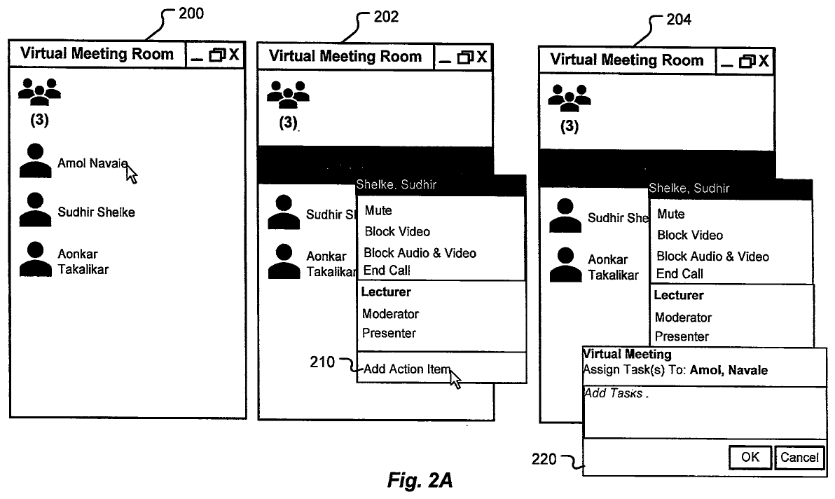

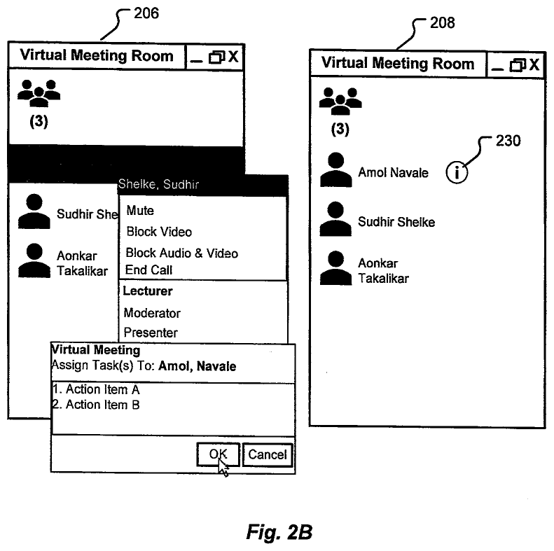

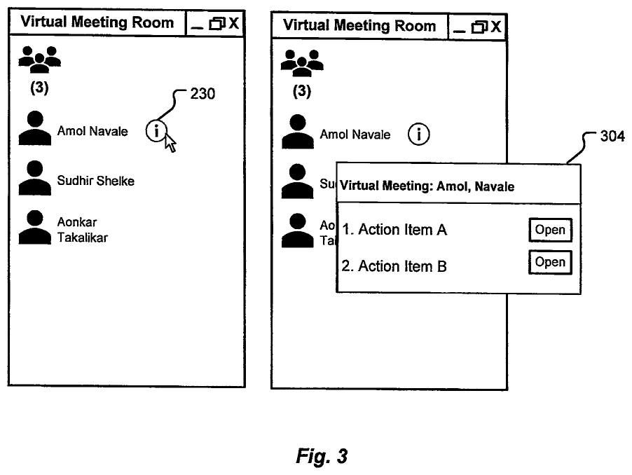

For example, during a meeting (e.g., video conference), a stakeholder/supervisor create one or more action items, as illustrated in FIGS. 2-3. The stakeholder/supervisor may assign each action item, or the system may use AI to assign each action item. In some embodiments, some action items may be manually assigned, and others automatically assigned by the system. The system may evaluate criterion in assigning action items. For example, the system may consider factors, such as but not limited to, resource availability, co-location (of assigning supervisor and/or other resources), skills/expertise required, etc. After the action item has been created and/or assigned, the system also tracks ongoing communications to determine the status of each action item. For example, one or more of the action items may be referenced in an email, for example, the email subject is the project name, and/or the sender is the assigning supervisor. The system uses AI and/or machine learning to track and monitor communications over multiple channels to determine the status of each action item. Continuing the example, the email chain may be related to additional action items for the project, the system may determine that additional actions items should be created/assigned. The newly created action items may be assigned to the same resource to ensure continuity of work. In another example, the email may be a status inquiry from the supervisor, based on the communication, the system may determine that the action item needs to be re-assigned. The system automatically re-assigns the action items and may notify all parties of the re-assignment. In another embodiment, the system may send a message to the supervisor user indicating that re-assignment is suggested and ask the supervisor to approve/deny the re-assignment. If the re-assignment is approved, the system updates the action item and may automatically send a message to the resource that has been assigned to and the resource that has been removed.

In an example in the healthcare sector, the system and method may be implemented in a hospital or other medical environment. For example, a patient's condition is being monitored by the patient's multiple doctors. The various care providers may communication regarding the patient's condition through calls, chats, email, etc. In some embodiments, the patient's doctors work in different departments (e.g., oncology, internal medicine, cardiology, neurology, etc.) in the same hospital and communication using a unified communication system. The servers for the various communications (e.g., call, email, chat, etc.) may sync with centralized server.

The system monitors information about the patient's condition over the various communication systems. For example, the patient may be identified using a unique identifier. The system monitors communications and when the unique identifier is included in a communication, the communication is associated with the patient. The system may analyze the communication to determine if any action items should be generated. Additionally, the case may be discussed in at a conference. Additionally, the system may co-relate this patient's case with similar cases which have occurred in the past. Based on this information, the system may lay out a few probable courses of action and will break each course of action down into action items which should be carried out in the planned time frame to accomplish the respective course of action. The courses of action may be presented to the stakeholders (e.g., doctors), and the stakeholders may select the course of action that is best suited to the situation, additionally or alternatively, the system may determine the best course of action. The selected course of action is broken down into action items and assigned to the appropriate resources. The action items may involve specialists required to perform tests and surgeries. The system may allocate the action items automatically based on area of expertise and availability. The schedule of treatment and the procurement of the necessary equipment could be planned by the system in advance as part of the action items to be carried out.

The system may track the subsequent communications (e.g., periodic medical reports, test results, journal articles, etc.) between the involved stakeholders and owners of the action items and will update the status of the action items based on the communications. Additionally, the system may analyze and assess the progress of the chosen course of action and suggest necessary improvements to ensure the time frames, best care, etc. In this way, the doctors will not have to manually determine and track action items; and also have the advantage of the ability to process more data (historical and current) to help them provide care to the patient.

In another example, the system may be utilized in the food industry. For instance, if a company wants to expand into different types of offerings or different locations. The communications received from its customers in a contact center may serve as a feedback mechanism about which area (e.g., offerings, geographical locations, etc.) they should expand in and other improvements that can be implemented. In regard to determining areas of expansion, the communications may be analyzed to identified communications related to the topic of expansion (e.g., keywords). Additionally, stakeholders (e.g., members of the management) may be discusses expansion. In some embodiments, for collecting data from call, the system may either record the call or may use a speech to text technique and the text can be stored at respective server.

The information collected from the contact centers (e.g., customer feedback) is processed with the information from the stakeholders to determine probable areas of expansion in locations as well as food items. Based on the determined areas of expansion, various courses of actions could then be laid out by the system. The system may use past case studies that have successfully achieved such expansion as one factor in determining probable courses of action. The probable courses of actions would then be broken down into action items and assigned to the resources based on preferences. The action items may involve procurement of new land, new ingredients, supply chain management of the respective areas and based on the identified action items, resources (e.g., action item owners) will be selected and assigned according to domain, location, availability, budget, etc. The actions items taken with respect to the selected courses of actions will be tracked and the statuses updated. In some embodiments, the tracking comprises continued analysis of subsequent communications.

In assigning and tracking action items, the system may determine a score for each resource. For example, taking the factors discussed above, each factor may be represented by f1 to fn. Further, each factor may have an associated weight (w1 to win). The weights for each factor for each resource may be based on their past performances and other factors. The system may maintain a database in which the scores are maintained for each of the probable assignee.

For example, the system identifies an action item to fix a customer escalation. The system additionally, identifies one or more probable candidates for the identified action item: Alice, Bob, and Carl from the escalation team. The system calculates the score for each of the probable assignees using the formula:

Score=Σ(w_i*f_i)

where i goes from 1 to n

Based on the equation, Alice, Bob and Carl's score for the particular assignment would be calculated. In this example, Alice's score based on her factors and their associated weight values would come out to be 550, Bob's score is 430, and Carl's score is 480. Therefore, in this example, Alice has highest score, and therefore, Alice would be assigned the action item. However, each resource's score may change during the duration of the action item and/or task.

During the progress of the task, communications with Alice regarding the action item(s) and/task/user story would be tracked by the system and her score would continuously be calculated to determine if Alice is on track with the task based on the completion of the action items (e.g., sub-tasks) Alice finishes as part of the assignment. Based on the type of feedback the system receives concerning the factors, the system will then re-adjust the weights w1 to wn accordingly. For example, if Alice or her supervisors compliment Alice on choosing the particular technology or method to solve an issue then the weight related to the factor of her area of expertise would increase. Conversely, if Alice applies for a previously unplanned leave then the weight related to the factor of her availability would decrease. The direct feedback of the concerned participants of the conversation would also be used to alter the weights. For example, if the project manager Richard does not like Alice's assignment to the task, and he voices his concern in a communication, then the likelihood of Alice getting assigned similar tasks would decrease (e.g., the factor related to the preference of the action item owner would decrease, causing her overall score for the particular action item to decrease).

This feedback mechanism subsequent to the assignment of the action items adjusts the weights of the factors which are associated with the assignee in a reinforced machine learning algorithm so that the system can continuously learn and benefit from the decisions it has made in the past. This way a system of matrices and factors which continuously re-adjust themselves based on the communications improves assignment to the best possible resource.

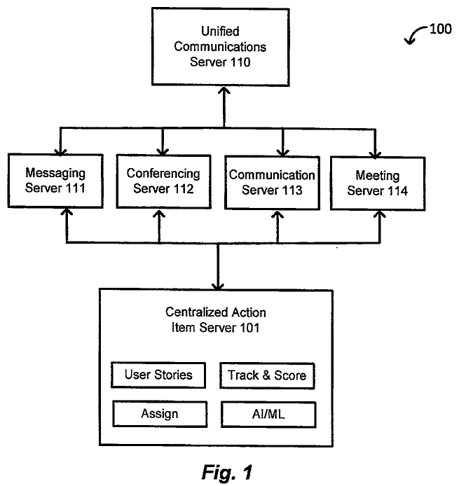

FIG. 1 is a block diagram of a first illustrative system 100 for assigning action items using AI based on criterion. The first illustrative system 100 comprises centralized action item server 101, unified communication system 110, messaging server 111, conferencing server 112, communication server 113, and meeting server 114. The centralized action item server 101 includes user stories, action item assignment, tracking and scoring, and AI/ML components.

Although not shown, the various servers illustrated in FIG. 1 may communicate over a network. The network can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), video protocols, Instant Messaging (IM) protocols, text messaging protocols, and/or the like. Thus, the network is an electronic communication network configured to carry messages via packets and/or circuit switched communications.

FIGS. 2A-B illustrate an example sequence of a user interface for manually generating action item(s).

As illustrated in FIG. 2A, in the first sequence 200, three users Amol, Sudhir, and Aonkar are shown in a conference. The moderator may want to assign action items to one or more of the participants. In some embodiments, only the moderator is allowed to assign action items. In order to assign an action item, the moderator may right-click on the name of the participant to be assigned the action item. For example, the moderator Sudhir may right-click on participant Amol and select add action item 210 (sequence 202). This opens the dialog box 220 shown in the sequence 204, which allows the moderator user to add/assign tasks to a participant user. The sequence is continued in FIG. 2B, after the moderator enters the tasks, he may hit “ok” (sequence 206). After participant Amol has been assigned one or more action items, an information icon 230 is displayed next to his name. Amol or other participants may click on the information icon 230 to view the action items assigned to Amol (sequence 208), as illustrated in FIG. 3. When a user clicks on the information icon 230 (sequence 300), another screen/popup 304 is display, which lists the action items assigned to the participant (sequence 302).

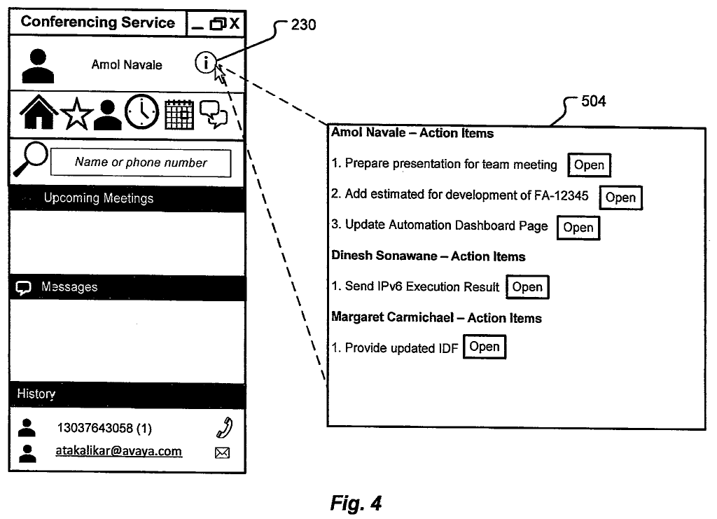

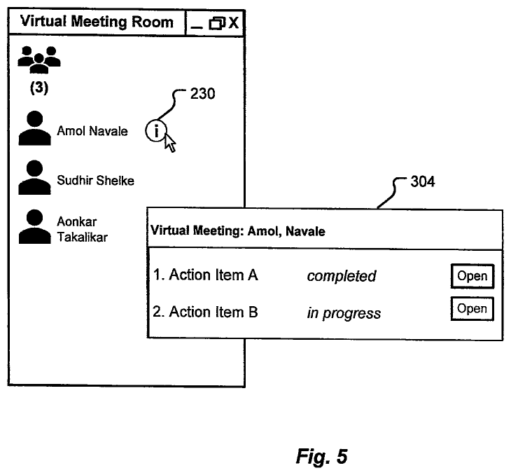

FIG. 4 illustrates the user interface for the assignee. When the assignee clicks the information icon 230 the action items assigned to the user are displayed along with meeting details. The display may include the status for each action item (e.g., in progress, delayed, completed, etc.), as illustrated in FIG. 5.

FIG. 5 illustrates an example of the conference service user interface, the next time the user logs in, the action items have been updated with their current status.

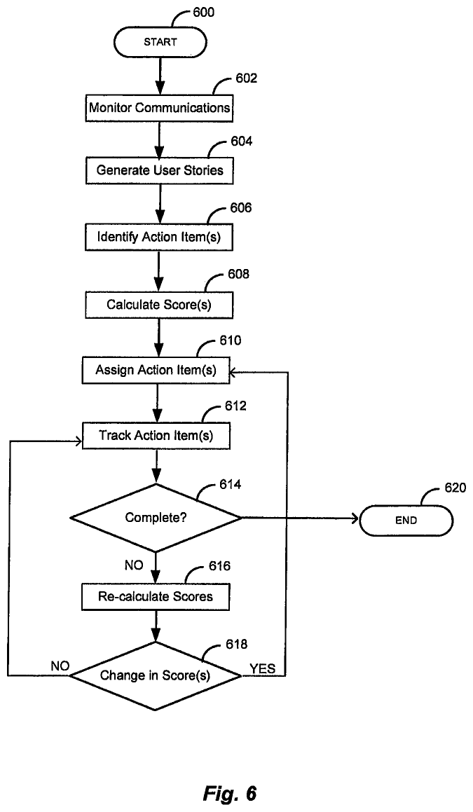

FIG. 6 is a flow diagram illustrating a process for assigning action items using AI

Modules are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one of skill in the art would recognize that the steps in FIGS. 2-5 may be implemented in different orders and/or be implemented in a multi-threaded environment. Moreover, various steps may be omitted or added based on implementation.

The process starts in step 600. In step 602, the system monitors communications, the communications may be received by a unified communication system from multiple communication channels (e.g., voice, chat, email, etc.). The communications are processed/analyzed to generate user stories (step 602). The user stories may associate related action items into a bigger picture (e.g., task, assignment, project, etc.). The system processes the user stories to identify action item(s) (step 606). This may include determining probable courses of action to accomplish the task or project, which may be based on past scenarios. Once action items are identified, resources may be identified and scored (step 608). For example, the resources may be scored on factors, such as but not limited to, availability, location, skills, etc. Additionally, the factors may be weighted, resource with more availability will have a higher weight for the availability factor. The resource with the highest score is assigned the action item (step 610). The system monitors further communications related to assigned action items to track the action items (step 612), which may include automatically updating the status of the action item. In step 616, if the action item is complete, the process ends at 620. If the action item is not complete (e.g., pending, in process, delayed, etc.), the system continuously re-calculates scores for resources (step 616). In step 618, if the scores of the resource(s) change (yes), then the action item is re-assigned (step 610). If the scores of the resource(s) does not change (no), the system continues to track the action item (step 612).

The above discussion describes various systems and ways that information may be captured. One of skill in the art would recognize that system may use various combination of what is discussed above to assign action items using AI based on preferences.

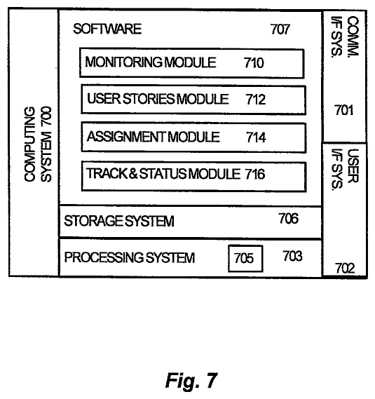

FIG. 7 illustrates computing system 700 used to assigning action items using AI based on preferences as described herein, according to one implementation. Computing system 700 is representative of any computing system or systems with which the various operational architectures, processes, scenarios, and sequences disclosed herein for assigning action items.

Computing system 700 is an example of centralized action item server 101, although other examples may exist. Computing system 700 comprises communication interface 701, user interface 702, and processing system 703. Processing system 703 is linked to communication interface 701 and user interface 702. Processing system 703 includes a microprocessor and/or processing circuitry 705 and storage system 706 that stores operating software 707. Computing system 700 may include other well-known components such as a battery and enclosure that are not shown for clarity. Computing system 700 may comprise a server, a user device, a desktop computer, a laptop computer, a tablet computing device, or some other user communication apparatus.

Communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In some implementations, communication interface 701 is configured to communicate with other end user devices, wherein the communication interface is used to identify and assign action items in system 100.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples.

Processing circuitry 705 comprises a microprocessor and other circuitry that retrieves and executes operating software 707 from storage system 706. Storage system 706 may include volatile and nonvolatile, removable and non-removable media implemented in any method or technology for storage of information, such as computer readable instructions, data structures, program modules, or other data. Storage system 706 may be implemented as a single storage device but may also be implemented across multiple storage devices or sub-systems. Storage system 706 may comprise additional elements, such as a controller to read operating software 707. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 705 is typically mounted on a circuit board that may also hold storage system 706 and portions of communication interface 701 and user interface 702. Operating software 707 comprises computer programs, firmware, or some other form of machine-readable program instructions. Operating software 707 includes monitoring module 710, user stories module 712, assignment module 714, and track and status module 716, although any number of software modules within the application may provide the same operation. Operating software 707 may further include an operating system, utilities, drivers, network interfaces, applications, or some other type of software. When executed by processing circuitry 705, operating software 707 directs processing system 703 to operate computing system 700 as described herein.

In at least one implementation, monitoring module 710, when read and executed by processing system 703, directs processing system 703 to monitor communications over multiple communication channels in accordance with the present disclosure. User stories module 712 when read and executed by processing system 703, directs processing system 703 to analyze the communications to generate user stories, which may be used to determine probable courses of action and/or action items. Assignment module 714, when read and executed by processing system 703, directs processing system 703 to score available resources and assign the action item to the highest scoring resource. Track and status module 716, when read and executed by processing system 703, directs processing system 703 to track actions items by monitoring further communications related to the action item, and update the status of the action item based on the further communications. The track and status module 716, when read and executed by processing system 703, may direct processing system 703 re-assign an action item as necessary.

In one embodiment, a method for dynamically assigning action items using Artificial Intelligence, the method comprising: monitoring communications over one or more communication channels; analyzing the monitored communications to generate one or more user stories; processing the one or more generated user stories to identify one or more action items; scoring one or more resources based on assignment factors to determine a resource with a highest score; and assigning the one or more action items to the resource with the highest score.

Aspects of the embodiment include: monitoring further communications over the one or more communication channels; tracking the one or more action items; and updating a status associated with each action item.

Aspects of the embodiment include: re-scoring the one or more resources based on the assignment factors to determine if scores associated with the one or more resources has changed; and in response to the scores associated with the one or more resources changing, re-assigning the one or more action items.

Aspects of the embodiment include: the assignment criterion includes at least one of: resource location, resource availability, one or more required skills, and/or stakeholder preference.

Aspects of the embodiment include: the one or more communication channels include: voice calls, video calls, email, instant messaging, chat, text messaging, and/or meeting minutes.

Aspects of the embodiment include: analyzing the monitored communications to generate the one or more user stories comprises detecting one or more keywords in the monitored communications.

Aspects of the embodiment include: analyzing the monitored communications to generate the one or more user stories comprises grouping related action items.

In another embodiment, a system comprising: a microprocessor; and a computer readable medium, coupled with the microprocessor and comprising microprocessor readable and executable instructions that cause the microprocessor to: monitor communications over one or more communication channels; analyze the monitored communications to generate one or more user stories; process the one or more generated user stories to identify one or more action items; score one or more resources based on assignment factors to determine a resource with a highest score; and assign the one or more action items to the resource with the highest score.

Aspects of the embodiment include: instructions to monitor further communications over the one or more communication channels; track the one or more action items; and update a status associated with each action item.

Aspects of the embodiment include: instructions to re-score the one or more resources based on the assignment factors to determine if scores associated with the one or more resources has changed; and in response to the scores associated with the one or more resources changing, re-assign the one or more action items.

Aspects of the embodiment include: assignment criterion includes at least one of: resource location, resource availability, one or more required skills, and/or stakeholder preference.

Aspects of the embodiment include: the one or more communication channels include: voice calls, video calls, email, instant messaging, chat, text messaging, and/or meeting minutes.

Aspects of the embodiment include: instructions to detect one or more keywords in the monitored communications.

Aspects of the embodiment include: instructions to group related action items.

Another embodiment includes a non-transitory computer readable medium having stored thereon instructions that, when executed by a processor, perform a method comprising: monitoring communications over one or more communication channels; analyzing the monitored communications to generate one or more user stories; processing the one or more generated user stories to identify one or more action items; scoring one or more resources based on assignment factors to determine a resource with a highest score; and assigning the one or more action items to the resource with the highest score.

Aspects of the embodiment include: monitoring further communications over the one or more communication channels; tracking the one or more action items; and updating a status associated with each action item.

Aspects of the embodiment include: re-scoring the one or more resources based on the assignment factors to determine if scores associated with the one or more resources has changed; and in response to the scores associated with the one or more resources changing, re-assigning the one or more action items.

Aspects of the embodiment include: the assignment criterion includes at least one of: resource location, resource availability, one or more required skills, and/or stakeholder preference.

Aspects of the embodiment include: the one or more communication channels include: voice calls, video calls, email, instant messaging, chat, text messaging, and/or meeting minutes.

Aspects of the embodiment include: analyzing the monitored communications to generate the one or more user stories further comprises detecting one or more keywords in the monitored communications.

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for dynamically assigning action items using Artificial Intelligence, the method comprising:
monitoring communications over one or more communication channels;
analyzing the monitored communications to generate one or more user stories;
processing the one or more generated user stories to identify one or more action items;
scoring one or more resources based on assignment factors to determine a resource with a highest score; and
assigning the one or more action items to the resource with the highest score.

2. The method of claim 1, further comprising:
monitoring further communications over the one or more communication channels;
tracking the one or more action items; and
updating a status associated with each action item.

3. The method of claim 1, further comprising:
re-scoring the one or more resources based on the assignment factors to determine if scores associated with the one or more resources has changed; and
in response to the scores associated with the one or more resources changing, re-assigning the one or more action items.

4. The method of claim 1, wherein the assignment criterion includes at least one of: resource location, resource availability, one or more required skills, and/or stakeholder preference.

5. The method of claim 1, wherein the one or more communication channels include: voice calls, video calls, email, instant messaging, chat, text messaging, and/or meeting minutes.

6. The method of claim 1, wherein analyzing the monitored communications to generate the one or more user stories comprises detecting one or more keywords in the monitored communications.

7. The method of claim 1, wherein analyzing the monitored communications to generate the one or more user stories comprises grouping related action items.

8. A system comprising:
a microprocessor; and
a computer readable medium, coupled with the microprocessor and comprising microprocessor readable and executable instructions that cause the microprocessor to:
monitor communications over one or more communication channels;
analyze the monitored communications to generate one or more user stories;
process the one or more generated user stories to identify one or more action items;
score one or more resources based on assignment factors to determine a resource with a highest score; and
assign the one or more action items to the resource with the highest score.

9. The system of claim 8, wherein the executable instructions further cause the microprocessor to:
monitor further communications over the one or more communication channels;
track the one or more action items; and
update a status associated with each action item.

10. The system of claim 8, wherein the executable instructions further cause the microprocessor to:
re-score the one or more resources based on the assignment factors to determine if scores associated with the one or more resources has changed; and
in response to the scores associated with the one or more resources changing, re-assign the one or more action items.

11. The system of claim 8, wherein the assignment criterion includes at least one of: resource location, resource availability, one or more required skills, and/or stakeholder preference.

12. The system of claim 8, wherein the one or more communication channels include: voice calls, video calls, email, instant messaging, chat, text messaging, and/or meeting minutes.

13. The system of claim 8, wherein the executable instructions cause the microprocessor to detect one or more keywords in the monitored communications.

14. The system of claim 8, wherein the executable instructions further cause the microprocessor to group related action items.

15. A non-transitory computer readable medium having stored thereon instructions that, when executed by a processor, perform a method comprising:
monitoring communications over one or more communication channels;
analyzing the monitored communications to generate one or more user stories;
processing the one or more generated user stories to identify one or more action items;
scoring one or more resources based on assignment factors to determine a resource with a highest score; and
assigning the one or more action items to the resource with the highest score.

16. The computer readable medium of claim 15, wherein the instructions when executed by a processor, perform the method further comprising:
monitoring further communications over the one or more communication channels;
tracking the one or more action items; and
updating a status associated with each action item.

17. The computer readable medium of claim 15, wherein the instructions when executed by a processor, perform the method further comprising:
re-scoring the one or more resources based on the assignment factors to determine if scores associated with the one or more resources has changed; and
in response to the scores associated with the one or more resources changing, re-assigning the one or more action items.

18. The computer readable medium of claim 15, wherein the assignment criterion includes at least one of: resource location, resource availability, one or more required skills, and/or stakeholder preference.

19. The computer readable medium of claim 15, wherein the one or more communication channels include: voice calls, video calls, email, instant messaging, chat, text messaging, and/or meeting minutes.

20. The non-transitory computer readable medium of claim 15, wherein analyzing the monitored communications to generate the one or more user stories further comprises detecting one or more keywords in the monitored communications.
